(19) United States
(12) Patent Application Publication
(10) Pub. No.: US 2014/0244972 A1
(43) Pub. Date: Aug. 28, 2014

(54) METHOD AND APPARATUS FOR GAME PHYSICS CONCURRENT COMPUTATIONS

(71) Applicant: AiSeek Ltd., Ramat-Gan (IL)

(72) Inventors: Roy ARMONI, Givat Ada (IL); Ramon AXELROD, Holon (IL)

(73) Assignee: AiSeek Ltd., Ramat-Gan (IL)

(21) Appl. No.: 14/070,968

(22) Filed: Nov. 4, 2013

Related U.S. Application Data
(63) Continuation of application No. 12/785,837, filed on May 24, 2010, now abandoned.
Application No. 12/785,837 is a continuation-in-part of application No. 12/207,680, filed on Sep. 10, 2008, now Pat. No. 8,005,066.
Application No. 12/207,680 is a division of application No. 11/089,029, filed on Mar. 25, 2005, now Pat. No. 7,440,447.
(60) Provisional application No. 60/555,975, filed on Mar. 25, 2004.

(51) Int. Cl. A63F 13/30; G06F 17/50

(52) U.S. Cl. CPC A63F 13/12; G06F 17/5009
USPC 712/17

(57) ABSTRACT

An apparatus for physical properties computation comprising an array processor. The array processor comprises of a plurality of processing elements, said processing elements arranged in a grid. A processing unit (PU) is coupled to the array processor. A local memory is coupled to the PU. The PU broadcasts data to rows of said processing elements in said grid, and performs physical computations in an order of complexity of O((√N) log N).

This application is a Continuation of U.S. patent application Ser. No. 12/785,837, filed on May 24, 2010, which is a Continuation-in-part of U.S. patent application Ser. No. 12/207,680, filed on Sep. 10, 2008, which is a divisional patent application of now U.S. Pat. No. 7,440,447, and that further claims priority from U.S. provisional patent application 60/555,975 filed on 25 Mar. 2004, all of which Applications are incorporated herein by reference.

### TECHNICAL FIELD

This disclosure generally relates to performing physical computations, and more specifically with simulations of rigid and flexible bodies using an array processor.

### BACKGROUND

Physics computations are broadly used in games and may be based on the rules of classical mechanics to compute the state of bodies at each point in time. As long as bodies do not collide, inertia, gravitation and acceleration may be used to compute the next state of bodies. Such computations may be performed in parallel by means of dedicated parallel hardware. An example of such computation is shown in U.S. patent application Ser. No. 10/715,440, publication number 20050075849, entitled “Physics Processing Unit” by Maher et al., and which is hereby incorporated by reference for all of the useful information it may contain.

Real world simulation, however, do involve collisions between pairs of bodies. For a colliding pair of bodies, contact resolution involves finding the contact point and computing the forces acting at on that point on each body in the pairs of bodies. These additional forces are integrated with the rest of each body parameters for each body in the pairs of bodies, and are used to compute its next state.

Currently available methods, based on parallel hardware, cannot efficiently detect collisions in parallel because of the huge number of pairs of bodies typical in many scenarios in general, and in games in particular. Conventionally, this complex problem is solved as a sequential process by sorting the bodies in the scene three times, according to their projection on the three axes in the three dimensional space, and detecting collisions in each axis separately. This complex problem may be accomplished in the order of O(N log N) times.

Alternatively, dedicated data structures are built to maintain pairs of colliding candidates, with an amortized update time of O(log N). If there is a separation between two bodies in their respective projection on at least one of the axes, according to this method these two bodies cannot collide. Such a broad phase collision detection process, for culling away objects that cannot possibly collide, rules out the vast majority of body pairs, leaving a narrow phase collision detection process, for accurate collision detection, to be performed only on a fraction of the body pairs. This process may be parallelized easily by existing hardware.

However, either the dependency on a sequential process for the broad phase collision detection, or the application of narrow phase collision detection on every possible pair of bodies in the scene, create a severe bottleneck to the acceleration of physics computations in general and real world simulation for games in particular.

It would be advantageous to provide a solution that overcomes the deficiencies in conventional approaches to the above described problem. It would be further advantageous that such a solution would perform in an order that is lower than the best order provided by conventional technologies.

### SUMMARY

To realize some of the advantages described above, there is provided an apparatus for physical properties computation comprising an array processor. The array processor comprises of a plurality of processing elements, said processing elements arranged in a grid. A processing unit (PU) is coupled to the array processor. A local memory is coupled to the PU. The PU broadcasts data to rows of said processing elements in said grid, and performs physical computations in an order of complexity of O((√N) log N).

More specifically, the grid is a n-by-n 1-grid.

More specifically, at least a processing element of said plurality of processing elements further comprises a local register file.

More specifically, the physical computations comprise real-world simulations.

Still more specifically, the real-world simulations are simulations for games.

Still more specifically, the real-world simulations further comprise concurrent processing of broad phase collision detection.

Still more specifically, the real-world simulation further comprise sorting in concurrent the results of said broad phase collision detection for each axis from a starting point.

Still more specifically, sorting the results further comprises a concurrent two-dimensional array sorting.

Still more specifically, said array sorting is a Shear sorting.

Still more specifically, the real-world simulation further comprise parallel processing of narrow phase collision detection.

Still more specifically, the narrow phase collision detections comprises triangle-triangle intersection.

Another aspect of the disclosed teachings is a computerized method for performing physical properties computation comprising loading processing elements of an array processor with a description of bodies. A broad phase collision detection for each axes by using concurrent processing on the array processor. The results of the broad phase collision detection are stored for each axis from a starting point by using concurrent processing on said array processor. A narrow phase collision detection is performed on the sorted results by using parallel processing on said array processor. The array processors are coupled to a processing unit (PU) which is further coupled to a local memory and the array processors performs the physical properties computation in an order of complexity of O((√N) log N).

More specifically, the technique further comprises determining for each colliding pair from said bodies forces subjected on each such body by using parallel processing on said array processor. The steps of the method are repeated if additional states are to be determined.

### BRIEF DESCRIPTION OF THE DRAWINGS

For better understanding of the disclosed teachings and to show how the same may be carried into effect, reference will now be made, purely by way of example, to the accompanying drawings. The particulars shown in the figures are by way of example and for purposes of illustrative discussion of the teachings, and are presented in the cause of providing what is believed to be most useful and readily understood description of the principles and conceptual aspects of the teachings. In this regard, no attempt is made to show structural details in more detail than is necessary for a fundamental understanding of the teaching, the description taken with the drawings making apparent to those skilled in the art how the teaching maybe embodied in practice. In the accompanying drawings:

FIG. 1—is a high-level block diagram an aspect of the disclosed teachings;

FIG. 2—is a top-level architecture of an exemplary graph-processing unit;

FIG. 3—is an architecture of an exemplary control unit;

FIG. 4—is an architecture of propagation unit;

FIG. 5—is a high-level block diagram of the disclosed teachings;

FIG. 6—is a top-level architecture of the array of processor elements;

FIG. 7—is a flowchart describing the method for performing physical computations in accordance with the disclosed teachings.

### DETAILED DESCRIPTION

An apparatus and a top-to-bottom concurrent method for classical mechanics computations on a concurrent processor is shown. In one embodiment it is used on rigid bodies that are approximated by decomposition into geometrical bodies for which intersection computation is easy. Decomposition may be into triangles in a two dimensional space, while in another embodiment the decomposition may be into triangular pyramids. One aspect of the invention is a concurrent method and apparatus for physics computations, performed in an order of complexity of O((√N) log N).

An exemplary system dedicated for such artificial intelligence (AI) tasks is described herein. This system could be embodied in a semiconductor chip. The system contains some or all of the followings: processors, configurable program memory, data memory, bus interface, dedicated logic for processing AI techniques, and a graph-processing unit.

The graph-processing unit holds a network of interconnected node, each of which comprises at least one digitally programmable delay. The network represents the weighted graph, where the delays act as the edges.

The delay is formed by a single counter in each node, a dedicated memory, also referred to as edges memory, and a comparator element on each edge between nodes. The edge is triggered once the memory is equal to the counter. This physical realization of a weighted graph is then used for searching minimal paths in a reduced time by injecting an electromagnetic pulse at the start node and letting it propagate through the entire network in parallel in accordance with the predetermined delays. Resetting all these counters allows the performing of a new test without the need to reload the graph representation.

The disclosed teaching is further aimed at allowing access to the system in one or more of the following manners: configuring the graph processing unit with one or more terrain representations (raster maps, navmesh, etc.), search-path queries, and terrain analysis queries, and other appropriate applications. The results are stored and accessible to the computer program. The graph-processing unit is supplemented with an embedded processor and dedicated logic for performing post-processing of the path-searching and terrain analysis queries. Accordingly the graph processing unit may be used iteratively to process the results with the aid of additional data memory.

In an embodiment of the disclosed teaching the embedded processor/s are used to manage and run the queries in batch mode. Each query in the batch is decoded, executed and answers stored in memory, the answers can be retrieved together or separately, as may be necessary. The processor can also change the order of queries in the batch for optimization. For example, it is possible to gather all queries for the same map, and units of the same size, into a single query.

The disclosed teaching further allows for the finding of the T-connected region connectivity in a highly efficient manner, by allowing the embedded processor to halt the propagation in the propagation unit inside the graph-processing unit after time T, and retrieve the nodes that the signal arrived at.

An exemplary implementation of a system with an architecture embodying the disclosed teaching is presented herein. Such a system contains processor/s, graph-processing unit, AI dedicated logic and peripherals (memory, interfaces, etc.). It is to be understood that the invention is not limited in its application to the details of construction and the arrangement of the components set forth in the following description or illustrations in the drawings.

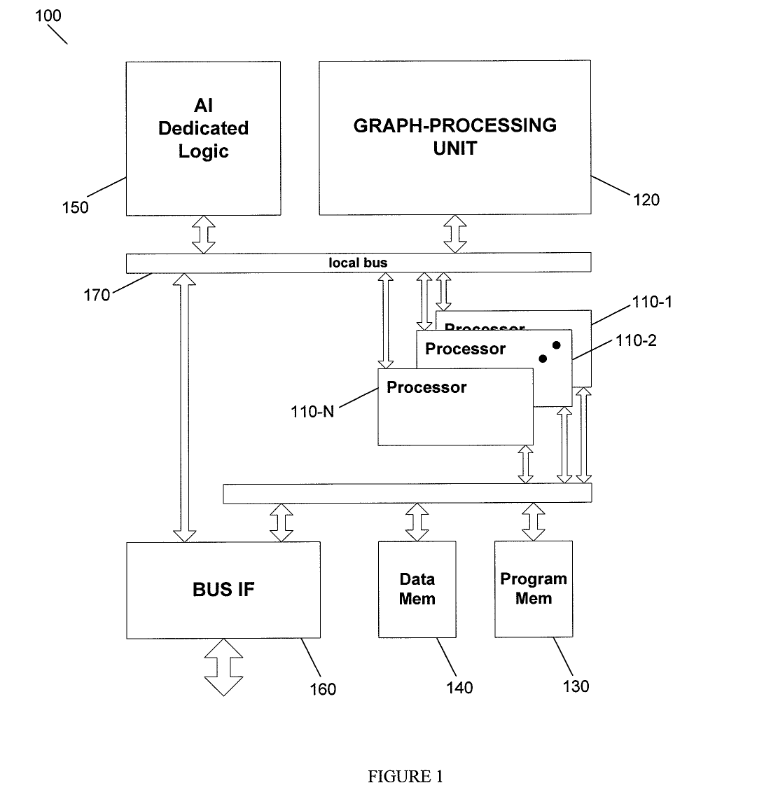

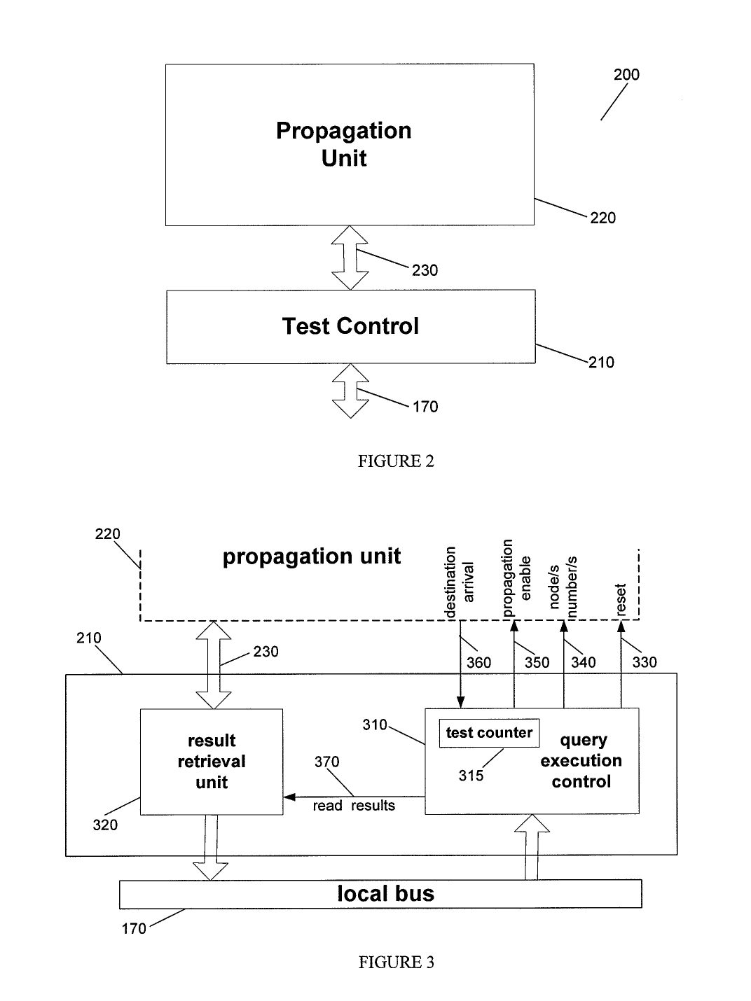

Reference is now made to FIG. 1 that is an exemplary and non-limiting description of a preferred high-level block diagram of such a system 100. In this implementation, access to system 100 is performed via bus interface unit 160. Graph-processing unit 120 may be accessed directly, for example, by a computer program via the bus interface. Alternatively program memory 130 is uploaded with a batch of AI queries and other directives that are processed by one or more of plurality of processors 110 using embedded processing programs. Data memory 140 is used for aiding processors 110 while executing the program and for storing results of different queries. Graph-processing unit 120 is connected via local bus 170 to bus interface unit 160 and processors 110. Graph-processing unit 120 accepts requests for loading a map, searching a path, retrieving a node status and more. These are further explained in conjunction with FIG. 2 below.

The AI dedicated logic 150 is similarly connected to local bus 170 and performs preprocessing and post-processing of the AI queries, for example path-smoothing or string-pooling queries. The specific protocol used to connect bus interface unit 160 with its respective user may vary and should not be considered as limiting the scope of the disclosed teaching.

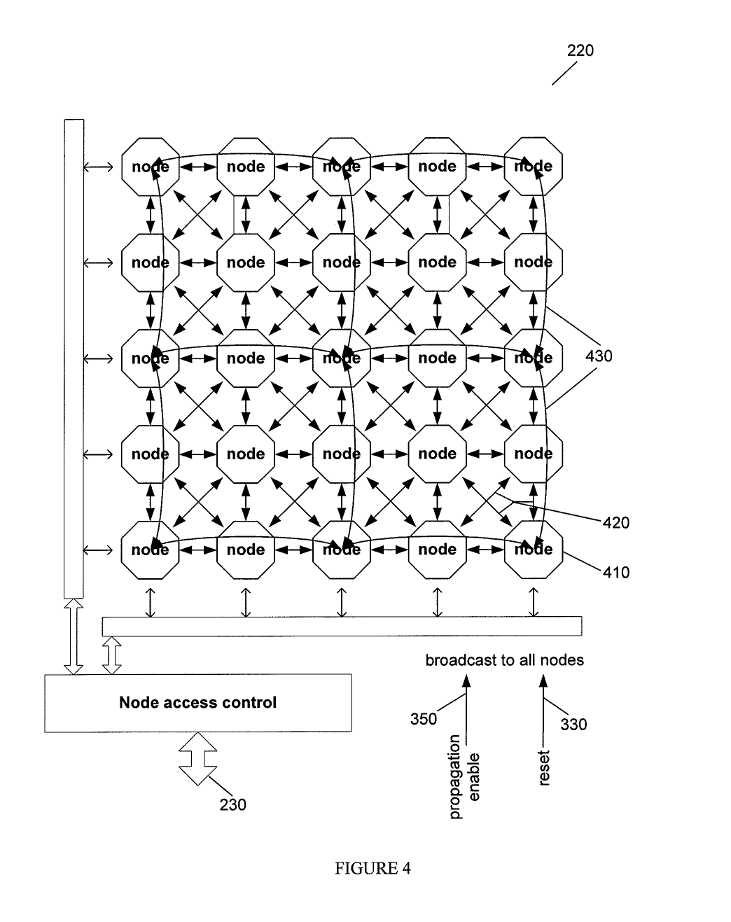

In referring to FIG. 2, there is described an exemplary and non-limiting top-level architecture of the graph-processing unit 120. Graph-processing unit 120 comprises of at least two building blocks: control unit 210 and propagation unit 220. Control unit 210 is responsible for accepting requests, for example from processors 110, AI dedicated logic 150, or through bus interface unit 160, driving propagation unit 22, and extracting the results. Control unit 210 is explained in further detail in conjunction with FIG. 3 below. Propagation unit 220 is a grid of nodes that are preferably connected as further described in FIG. 4, or in any other architecture, and further capable of storing a graph representation.

With reference to FIG. 3 there is described an exemplary and non-limiting architecture of control unit 210 of graph-processing unit 12. Query execution control 310 receives commands from local bus 170 to run a single query. Query execution control 310 then generates reset, through reset signal 330, in order to clear the state of propagation unit 220, drives propagation unit 220 with the node numbers 340 from which the signal should start propagating, resets and starts test-counter 315, and enables the signal propagation in propagation unit 220 by asserting propagation enable signal 350.

Execution ends when either test-counter 315 reaches a predefined time T in time limited queries, or, when the propagating signal in propagation unit 22 reaches a destination node indicated by destination arrival signal 360. At that point, query execution control 310 disables signal propagation of propagation unit 220 by stopping to assert propagation enable signal 350. Query execution control 310 then activates read result signal 370 to result retrieve unit 320, thereby indicating the ability to start reading the results from the propagation unit 220.

Reference is now made to FIG. 4 where an exemplary and non-limiting diagram of an architecture of the propagation unit 220 of graph-processing unit 120 is shown. Propagation unit 220 comprises of a plurality of nodes 410 forming an array of rows and columns of nodes 410. Adjacent nodes are connected via regular edges 420, and some of the nodes are connected via leaping edges 430. Each edge is attributed with a programmable private cost that determines the time it will take a signal to propagate throw it during a test. An exemplary architecture enables the processing of standard Real-Time-Strategy (RTS) maps. The presence of leaping edges 430 is essential for embedding general 3D scenes which use navmesh or waypoint graph. Before running a batch of queries, propagation unit 220 is configured with the representation of a map, i.e., edge costs', which are stored inside the plurality of nodes 410.

Each path-finding query begins by first resetting the state of all the nodes 410 by asserting signal 330, followed by selecting the nodes from which the signal will start to propagate. Thereafter propagation is enabled by asserting propagation enable signal 350. Each node 410 contains a counter that represents the time passed since the node was first reached, and holds information about the neighbor node from which the signal first arrived. This allows, once test execution is complete, the back tracing of the shortest-path to every node from the origins of propagation. Multiple tests of the same terrain representation can be achieved consuming minimal time by simply repeating the test flow once for each new test.

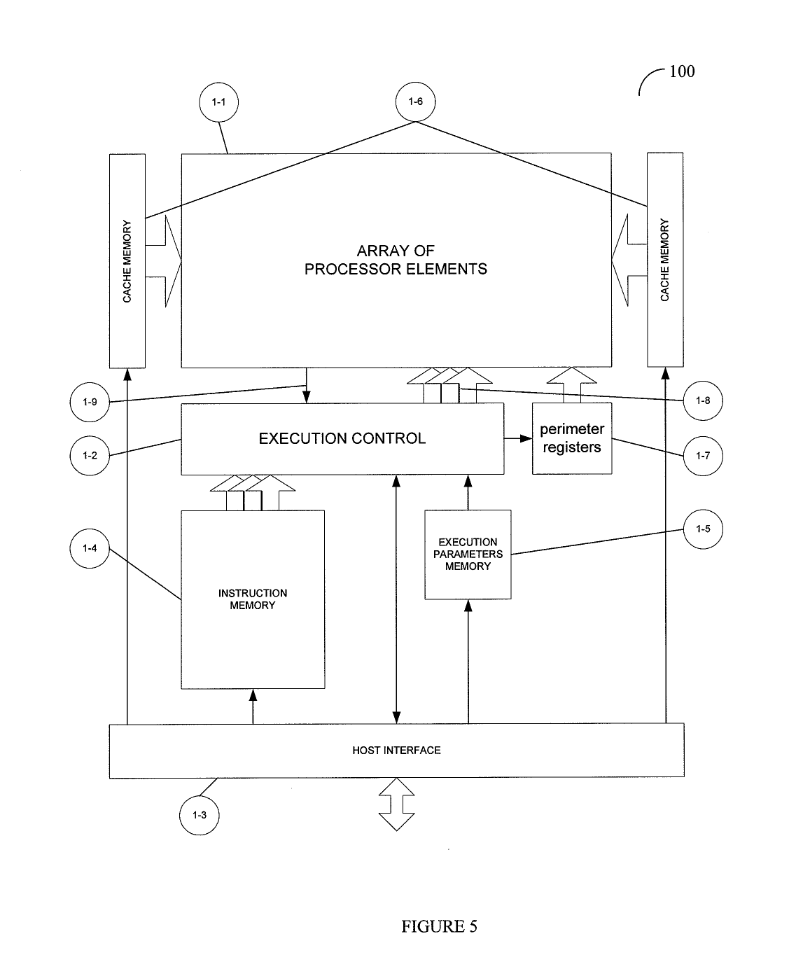

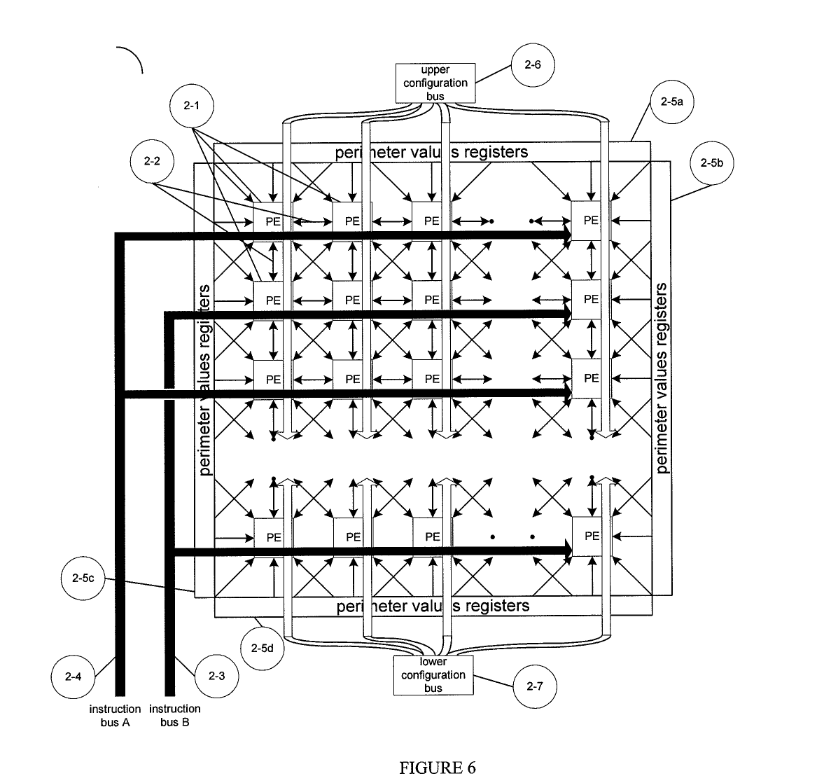

In order to better understand the description of the inventions disclosed herein a brief description of an array processor as described in FIGS. 5 and 6. In FIG. 5 an exemplary and non-limiting high-level block diagram 100, is shown. It comprises of several elements. An array of interconnected processor elements (PE) (1-1), described in further details in FIG. 6. Execution control module (1-2), is a logical state machine responsible of managing the input and output from the array. On the way into the array it is in charge of receiving requests from the host via the host interface (1-3) and execution parameters memory (1-5), and activating the array of processor elements (1-1) by driving the instruction buses (1-8) into the array from the instruction memory (1-4). It is also in charge of receiving indications, e.g., interrupts, through interrupts bus (1-9), terminating execution accordingly, and extracting results from the array back to the host via the host interface (1-3). Host interface (1-3), enables the host to communicate with the device, to pre-configure the instruction memory (1-4), program memory (1-5), and array caches (1-6), and to activate the execution control module (1-2). The instruction memory (1-4) is a memory that is pre-loaded with the instructions for the PE array that is driven via the instruction buses (1-8). The execution parameters memory (1-5) holds parameters governing the way the execution module (1-2) runs, that is a “block state” module. The host can request the device to perform a task described by the parameters in a block of the execution parameters memory. When such a request occur, the execution control module (1-2) reads the parameters of the routine from the execution parameters memory (1-5) and drives certain instructions from the instruction memory (1-5) to the array through the instruction buses (1-8). In preferred embodiment the execution parameters memory contains at least the addresses of the starting instruction ending instruction, and how many repetitions of the sets should be made. The execution parameters memory (1-5) is an addition to the hierarchy of execution, which enables easier operation of the system, and isn't limited to this specific way of execution. The cache memories (1-6) are dedicated to increase the bandwidth to the array. The array can be loaded with data from the cache memories (1-6), at idle state when no instructions are driven through the instruction buses (1-8), or at run time. The perimeter registers (1-7) holds the values which are driven to the perimeter processing elements of the array at certain occasion (described in the array description), in order to make the entire array homogeneous and eliminate the need to drive specific instruction set to these perimeter processors.

FIG. 6 shows an exemplary and non-limiting top-level architecture 200 of the array of processor elements. It includes the array of processor elements with emphasis on connectivity, both between processor elements and between the array and the logic around it. The Processor elements (PE) (2-1) are organized in a grid. A processor element is described in FIG. 4. Each processor element is connected to its adjacent processor elements with an exclusive bus for each of them (2-2). The array contains one or more buses carrying processor instructions to groups of processor elements. The processor elements receiving the same instructions per clock form execution groups. In one embodiment the entire array receives the same instruction bus. In another embodiment there are two execution groups interleaved (2-3,2-4), so that floating point operations can be performed efficiently by having execution group 1 (2-4) deal with the mantissa and execution group 2 (2-3) with the exponent. In order to be able to run the same set of instructions for internal and perimeter processor elements, perimeter values registers (2-5×) drive the perimeter processor elements inputs, resembling processor element outputs. Configuration of the array is done by writing into the processor elements' memory. In one embodiment the configuration is done by configuration buses driven through the entire array, and writing is done in a way that resembles writing a standard memory array. In one embodiment there are two configuration buses, upper configuration bus (2-6) and lower configuration bus (2-7), where the upper configuration bus (2-6) drives, for example, the upper half of the array, and the lower configuration bus (2-7) drives the lower half of the array. This enables configuration bandwidth to be doubled. This also reduces minimal path and enables increase in configuration frequency. Extraction of results from the array is done by reading from the processor elements. In one embodiment the configuration buses (2-6) are also used for reading from the processor elements generating a very wide read bus. In another embodiment the read is done constantly from a specific group of processor elements, and concurrently a program is executed on the entire array, utilizing the interconnections between the processor elements in order to transport results to this group of processor elements. Each PE can output a single bit that is the interrupt bit. Transportation of interrupts from the processor elements to the execution control module (2-1) is done by a hierarchical interrupt tree.

It should be noted that a graph, denoted by G, is a mathematical object defined by two sets, namely, a set of vertices denoted by V(G) and a set of edges denoted by E(G), where E(G) is a set of pairs (u,v) where both u and v are in V(G). A graph H is called a subgraph of G if V(H) is a subset of V(G). An m·n d-grid G is a graph of m·n vertices where V(G) is the set {(i,j): 1≦i≦m, 1≦j≦n}, and where E(G) is the set {((i,j),(k,l)): 1≦i,k≦n, 1≦j,l≦m, |i−k|≦d, |j−l|≦d, i#k or j#1}. For the scope of this disclosure, any graph isomorphic to an m·n d-grid is also considered an m·n d-grid. Concurrent processors, such as an array processor, may be arranged as graphs, wherein every processing element is uniquely mapped to a vertex in the graph, and two processing elements may access each others internal data only if there is an edge between their corresponding vertices in the graph. In the present invention, concurrent processors that are arranged as grids are considered, and are referred to as array processors.

The method disclosed herein is a few step long process, the process being performed by a device that consists of an array processor, local memory, and a central processing unit (CPU), as shown for example in FIGS. 5 and 6, thereby extracting the unique performance advantages of the disclosed teachings, in particular when a large number of bodies is concerned, and as explained in more detail herein below. The array processor is a concurrent processor arranged as an n·n 1-grid, where each processing element in the array processor has a local register file, thereby allowing concurrency of the disclosed method to achieve the performance advantages. The CPU can access the local memory of the device, and is able to broadcast data to rows of processing elements in parallel. For instance, the CPU may prepare a one-dimensional array of n words, and broadcast them to the array processor such that the i-th word in the array arrives at the n-th processing elements in the i-th row of the array processor.

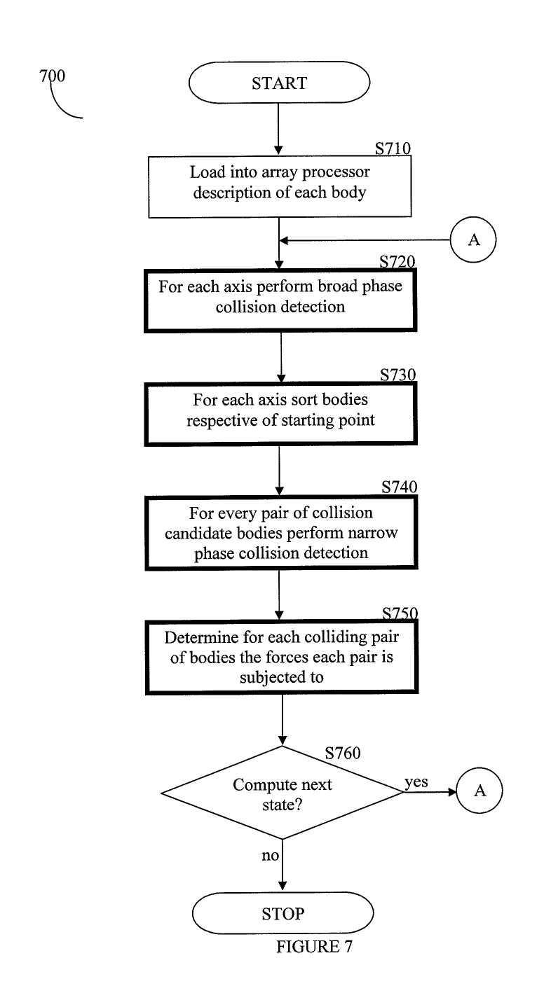

The method for physics simulation starts with N=n² bodies whose descriptions are stored in the local memory of the device, and further described with respect to the exemplary and non-limiting implementation shown in FIG. 7. Applicants note that it is difficult to show in a flowchart the concurrent nature of execution and therefore those steps that are performed using the concurrent processing capability of the array processor are marked by a double-line. The description of a body comprises of a unique identification (ID), coordinates of its vertices and of other physical data such as mass, velocity and direction, and acceleration or forces applied to the body, etc. The CPU loads the locations of the n² bodies into the array processor where each body's description is located in the register file of a single processing element (S710). Broad phase collision detection is then performed (S720) by projecting each element on the x axis. S720 is performed using the parallel processing capabilities of the system. Then, sorting (S730) of the bodies by their staring point on the x axis, which takes O(n log n) time by Shear sort, is performed. S730 is performed using the concurrent processing capabilities of the system. Then, every body keeps a pointer to the ID of the next bodies in the order that intersect it in the x axis, as long as there is enough memory. This is done in a time period O(m), where m is the number of local registers in a processing element that are available for keeping IDs of possible colliding bodies. Similarly, sorting and intersection detection is performed in the y and z axes, which is used to dilute, for each body, the list of potential colliding bodies. This is true since two bodies, whose respective projections on one of the axes do not collide, cannot collide in the three dimensional space.

The next step of the method is a narrow phase collision detection (S740), that is performed using the parallel processing capabilities of the system. It performs a more accurate method, such as the Tropp-Tal-Shimshoni algorithm, for triangle-triangle intersection. This algorithm checks every pair of collision candidates that survive the broad phase collision detection as possible candidates. This step is performed by loading in each processing element of the array processor a pair of bodies, and applying the Tropp-Tal-Shimshoni algorithm in parallel. In one embodiment, the loading of pairs may be done by moving a copy of every body's data back in sorted list one step, and performing Tropp-Tal-Shimshoni algorithm for the pairs that survived the broad phase collision detection. In another embodiment, all bodies are uploaded from the array processor to the local memory of the device, and then only pairs of bodies that survived the broad phase collision detection are downloaded back to the array processor, each pair in a different processing element.

The Tropp-Tal-Shimshoni algorithm, as well as many other algorithms for triangle-triangle intersection, performs many inner products. In one embodiment of the present invention, an inner product operation on floating point coordinates may be performed by first adjusting all mantissas according to the exponent of the result. This may be done for two three-dimensional vectors u and v, by taking the maximum over i of exponent(uᵢ)+exponent(vᵢ). The mantissas are then adjusted accordingly, for example, if i is the coordinate for which exponent(uᵢ)+exponent(vᵢ) is maximal, and exponent(uᵢ)+exponent(vᵢ)-exponent(uⱼ)-exponent(vⱼ) is 6, then uⱼ and vⱼ are each shifted right by 3. The inner product is then performed on the mantissas as integers without the need to normalize after every addition and every multiplication.

Finally, when collision detection is performed accurately, the method continues to compute for colliding pairs the forces they are subject to (S370). S370 is performed using the parallel processing capabilities of the system. Between any pair of colliding surfaces, forces orthogonal to the surfaces are applied. The computation of these forces is also done in parallel, following the narrow phase collision detection. Once this is done, the system is set for the computation of its next state (S370).

In one embodiment, the physics computations continue by integration of all parameters applied to bodies. Next state of every body in the system is computed using motion formulae and constraints. These computations are applied to each body separately, thus, are carried out completely in parallel, where each body's next state is computed by a different processing element in the array processor.

With respect to the disclosed invention and without limiting the scope of the invention, the following is disclosed: (1) a method for embedding of N=n² bodies in a concurrent processor arranged as an n·n 1-grid G such that physical computation are performed concurrently; (2) a method according to (1), wherein physical computations are real world simulations; (3) a method according to (2), wherein real world simulations are real world simulations for games; (4) a method and apparatus for concurrent physics computations; (5) a method and apparatus according to (4), wherein physical computations are real world simulations; (6) a method and apparatus according to (5), wherein real world simulations are real world simulations for games; (7) a method and apparatus according to (5) wherein real world simulations comprise broad phase collision detection; (8) a method and apparatus according to (7) wherein broad phase collision detection comprises sorting according to each axis of the three-dimensional space by means of a concurrent two-dimensional array sorting; (9) a method and apparatus according to (8) wherein sorting is Shear sorting; (10) a method and apparatus according to (5) wherein real world simulations comprise narrow phase collision detection; (11) a method and apparatus according to S10 wherein narrow phase collision comprises triangle-triangle intersection; (12) a method and apparatus according to (5) wherein real world simulations comprise contact resolution; (13) a method and apparatus according to (5) wherein real world simulations comprise classical mechanics computations; (14) a method and apparatus according to (13) wherein classical mechanics computations comprise motion formulae computations; and, (15) a method and apparatus according to S13 wherein classical mechanics computations comprise Newton laws constraints.

The invention disclosed hereinabove may be implemented in software, firmware, hardware, or any combination thereof. When implemented as software or certain types of firmware, the software contains instructions executable on a system, for example, a computer, that is enabled to execute the instructions so as to perform the methods and outcomes thereof, of the disclosed inventions. Other implementations of the principles disclosed hereinabove are also envisioned by those of regular skill-in-the-art, and are specifically and intentionally included as part of the disclosure. Therefore, the scope of the inventions should be only limited by the scope of the respective claims.

What is claimed is:

1. An apparatus for physical properties computation comprising:
an array processor, said array processor comprised of a plurality of processing elements, said processing elements arranged in a grid;
a processing unit (PU) coupled to said array processor; and
a local memory coupled to said PU;
wherein the PU broadcasts data to rows of said processing elements in said grid, and performs physical computations in an order of complexity of O((√N) log N).

2. The apparatus of claim 1, wherein said grid is a n-by-n 1-grid.

3. The apparatus of claim 1, wherein at least a processing element of said plurality of processing elements further comprises a local register file.

4. The apparatus of claim 1, wherein said physical computations comprise real-world simulations.

5. The apparatus of claim 4, wherein said real-world simulations are simulations for games.

6. The apparatus of claim 4, wherein said real-world simulations further comprise concurrent processing of broad phase collision detection.

7. The apparatus of claim 6, wherein said real-world simulation further comprise sorting in concurrent the results of said broad phase collision detection for each axis from a starting point.

8. The apparatus of claim 7, wherein said sorting the results further comprises a concurrent two-dimensional array sorting.

9. The apparatus of claim 8, wherein said array sorting is a Shear sorting.

10. The apparatus of claim 7, wherein said real-world simulation further comprise parallel processing of narrow phase collision detection.

11. The apparatus of claim 10, wherein said narrow phase collision detections comprises triangle-triangle intersection.

12. A computerized method for performing physical properties computation comprising:
loading processing elements of an array processor with a description of bodies;
performing for each axes a broad phase collision detection by using concurrent processing on said array processor;
sorting results of said broad phase collision detection for each axis from a starting point by using concurrent processing on said array processor; and
performing a narrow phase collision detection on sorted results by using parallel processing on said array processor;
wherein the array processors are coupled to a processing unit (PU) which is further coupled to a local memory and the array processors performs the physical properties computation in an order of complexity of O((√N) log N).

13. The method of claim 12, further comprising:
determining for each colliding pair from said bodies forces subjected on each such body by using parallel processing on said array processor; and
repeating the steps of the method if additional states are to be determined.

14. The method of claim 12, wherein said array processor is organized as an n-by-n 1-grid.

15. The method of claim 12, wherein said physical computations comprise real-world simulations.

16. The method of claim 15, wherein said real-world simulations are simulations for games.

17. The method of claim 12, wherein said sorting results further comprises a concurrent two-dimensional array sorting.

18. The method of claim 17, wherein said sorting is a Shear sorting.

19. The method of claim 12, wherein said narrow phase collision detections comprises triangle-triangle intersection.
